(19) United States
(12) Patent Application Publication
(10) Pub. No.: US 2023/0359490 A1
(43) Pub. Date: Nov. 9, 2023

(54) DEVICE, SYSTEM AND METHOD FOR SCHEDULING JOB REQUESTS

(71) Applicant: Shopee IP Singapore Private Limited, Singapore (SG)

(72) Inventor: Ang Kah Min KELVIN, Singapore (SG)

(21) Appl. No.: 18/312,612

(22) Filed: May 5, 2023

(30) Foreign Application Priority Data
May 5, 2022 (SG) 10202204751R

(51) Int. Cl. G06F 9/48

(52) U.S. Cl. CPC G06F 9/4881

(57) ABSTRACT

Various embodiments concern a method for scheduling job requests in an application layer or terminal device of a computer system, including the steps of: accessing a first queue storing a job request; determining if the job request in the first queue can be dispatched within a first pre-determined time, wherein if the job request is determined to be dispatchable within the first pre-determined time; determining if the job request that is dispatchable can be executed based on a system resource parameter; and dispatching the job request if the job request that is dispatchable is determined to be capable of being completed based on the system resource parameter.

### CROSS-REFERENCE TO RELATED APPLICATIONS

This non-provisional application claims priority to Singapore Patent Application No. 10202204751R, which was filed on May 5, 2022, and which is incorporated herein in its entirety.

### TECHNICAL FIELD

Various aspects of this disclosure relate to devices, systems and methods for scheduling job requests, in particular but not limited for congestion control at an application or service layer or a terminal device.

### BACKGROUND

Current task or job schedulers may be deployed in computing environments for various computer systems, and may adopt various algorithms, such as static or dynamic rate limiting techniques, to manage or minimize overload. At a computer network level, network congestion controllers may adopt bufferbloat or congestion control algorithms to minimize system or network overload. Existing rate limiting algorithms or bufferbloat algorithms may not account for dynamic changes, system resources, computing capacity, or may be overly complex in implementation, hence may be inefficient.

In addition, existing rate limiting algorithms are typically developed in the context of a network layer of a system and there is a lack of suitable congestion management algorithms for an application layer, or at a terminal device. This may in part be due to the lack of contextual consideration of the application layer and/or terminal device. For example, a Controlled Delay (CoDel) queue management system and the Bottleneck Bandwidth and Round-trip propagation time (BBR) may be suitable for network congestion control, but may not be tailored for congestion control at an application layer or a terminal device due to less flexibility to drop or abandon job requests (which may be in the form of data packets). In addition, networks place a high priority on forwarding of data packets which may not be of similar priority at the application layer or a terminal device.

Accordingly, efficient approaches to manage overloads and congestion, particularly for application to terminal devices and/or software application layers, are desirable.

### SUMMARY

The disclosure provides a technical solution in the form of a method, scheduler device/controller that is efficient in providing an efficient approach to manage overloads and congestion. The disclosure may be applied in various computing environment such as a software application layer (service layer), a computer device, a computer system, and/or a computer network. The technical solution takes into account processing resources and processing capacity within the computing environment to derive an indication of device, system or network overload, which is then used to determine whether a job request is to be dropped, wait in queue, or dispatched. The technical solution seeks to provide an integrated solution or two layered control for (a.) Snowball protection/Bufferbloat control; (b.) Overload protection/Concurrency control. The method is implemented based on the principles that a job request will not be dispatched for processing if the job request cannot be finished in time, and in addition, a job request will not be allowed to wait in a queue indefinitely and will be rejected as early as possible if it cannot be dispatched.

Various embodiments disclose a method for scheduling job requests in an application layer or terminal device of a computer system, including the steps of: accessing a first queue storing a job request; determining if the job request in the first queue can be dispatched within a first pre-determined time, wherein if the job request is determined to be dispatchable within the first pre-determined time; determining if the job request that is dispatchable can be executed based on a system resource parameter; and dispatching the job request if the job request that is dispatchable is determined to be capable of being completed based on the system resource parameter.

In some embodiments, if a duration of the job request in the first queue is determined to have exceeded the first pre-determined time, the job request is dropped from the first queue.

In some embodiments, the first pre-determined time is a function of the maximum duration allowable for the job request to remain in the first queue and an average execution time of previously dispatched job requests.

In some embodiments, the step of determining if the job request that is dispatchable can be completed includes a step of checking the number of previously dispatched job requests that are in a ready state but not executed as an indication of whether one or more physical executors are operating in an overload state.

In some embodiments, the indicator is expressed as a ratio of the number of previously dispatched job request(s) in the ready state is to the number of physical executors capable of executing the job request. The ratio may be 0.1 or 0.2.

In some embodiments, the physical executors are part of a multi-core processor, each physical executor corresponding to a core of the multi-core processor.

In some embodiments, if the number of previously dispatched job request(s) in the ready state is less than the ratio multiplied by the number of physical executors, the job request is dispatchable.

In some embodiments, the job request is stored in the first queue if the job request is determined to be not dispatchable.

In some embodiments, if the job request in the first queue is determined to be dispatchable within the first pre-determined time, further including the step of prioritizing the job request by a user-identity (user-ID) hash.

Another aspect of the disclosure provides a computer program element including program instructions, which, when executed by one or more processors, cause the one or more processors to perform the aforementioned method.

Another aspect of the disclosure provides a non-transitory computer-readable medium including program instructions, which, when executed by one or more processors, cause the one or more processors to perform the aforementioned method.

Another aspect of the disclosure provides a job scheduler configured to be on a dispatcher layer of an application framework, or placed before or after the dispatcher, the scheduler device configured to access a first queue storing a job request; determine if the job request in the first queue can be dispatched within a first pre-determined time, wherein if the job request is determined to be dispatchable within the first pre-determined time; determine if the job request that is dispatchable can be executed based on a system resource parameter; and dispatch the job request if the job request that is dispatchable is determined to be capable of being completed based on the system resource parameter.

In some embodiments, if a duration of the job request in the first queue is determined to have exceeded the first pre-determined time, the job request is dropped from the first queue.

In some embodiments, the first pre-determined time is a function of the maximum duration allowable for the job request to remain in the first queue and an average execution time of previously dispatched job requests.

In some embodiments, the determination of whether the job request that is dispatchable can be completed includes a check on the number of previously dispatched job requests that are in a ready state but not executed as an indication of whether one or more physical executors are operating in an overload state.

In some embodiments, the indicator is expressed as a ratio of the number of previously dispatched job request(s) in the ready state is to the number of physical executors capable of executing the job request.

Another aspect of the disclosure provides a congestion controller device including a communication interface arranged in data communication with a job request queue of a computer system, and a processing unit, the processing unit configured to access the job request queue storing a job request; determine if the job request in the job request queue can be dispatched within a first pre-determined time, wherein if the job request is determined to be dispatchable within the first pre-determined time; determine if the job request that is dispatchable can be executed based on a system resource parameter; and dispatch the job request if the job request that is dispatchable is determined to be capable of being completed based on the system resource parameter.

In some embodiments, the processor unit comprise a request queue controller module, and a ready queue controller module.

In some embodiments, the request queue controller module is used to determine if the job request in the first queue can be dispatched within a first pre-determined time and if so send the job request to the ready queue controller module.

### BRIEF DESCRIPTION OF THE DRAWINGS

The disclosure will be better understood with reference to the detailed description when considered in conjunction with the non-limiting examples and the accompanying drawings, in which:

FIG. 1 shows a flow diagram for performing a method for scheduling job requests.

FIG. 2 shows a system diagram of a controller device for scheduling job requests.

FIG. 3 illustrates a pseudocode of a request queue controller for determining if a job request is to be kept in a request queue or dropped.

FIG. 4 illustrates a pseudocode of a ready queue controller for determining if a job request is to be dispatched or kept in a request queue.

FIG. 5 illustrates an embodiment of the controller device implemented in a multi-core concurrency runtime environment.

FIG. 6 depicts dispatched job requests in ready states modelled as an imaginary ready queue.

FIG. 7 shows a controller or dispatcher device according to another embodiment.

FIG. 8 illustrates a possible application(s) of the congestion controller in a web framework.

FIG. 9A to 9E show test results demonstrating the efficacy of the method for scheduling job requests as a congestion controller.

FIG. 10 shows a standalone controller or dispatcher device according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices, systems or methods are analogously valid for the other devices, systems or methods. Similarly, embodiments described in the context of a device are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the term “module” refers to, or forms part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

As used herein, the term “job” refers to any activity executed by a computer system, either in response to an instruction or as part of normal computer operations. A job may include one or more tasks, which when executed, signify the execution of a job. Jobs may be submitted by a user via input/output (I/O) devices or may be initiated by an operating system of the computer. Examples of jobs include threads, processes, greenlets, goroutines, or data flows. Jobs in a computer system may be scheduled by a job scheduler, which determines the specific time and order associated in each job. Jobs may be processed or executed via batch processing or multitasking. In some embodiments, a job may also be in the form of a transaction request for purchasing goods and/or services from an e-commerce platform. The transaction request may be sent via a software application installed on a terminal device such as a smartphone.

As used herein, the term “scheduling” refers broadly to the assigning of computer resources, such as memory units/modules, processors, network links, etc. to perform or execute jobs. The scheduling activity may be carried out by a scheduler, which may be implemented as a data traffic controller module in some embodiments. Schedulers may be implemented to provide one or more of the following: load balancing, queue management, overload protection, concurrency control, snowball protection, bufferbloat control, congestion control, so as to allow multiple users to share system resources effectively, and/or to achieve a target quality-of-service.

As used herein, the term “terminal device” refers broadly to a computing device that is arranged in wired or remote data/signal communication with a network. Non-limiting examples of terminal device include at least one of the following: a desktop, a laptop, a smartphone, a tablet PC, a server, a workstation, Internet-of-things (IoT) devices. A terminal device may be regarded as an endpoint of a computer network or system.

In the following, embodiments will be described in detail.

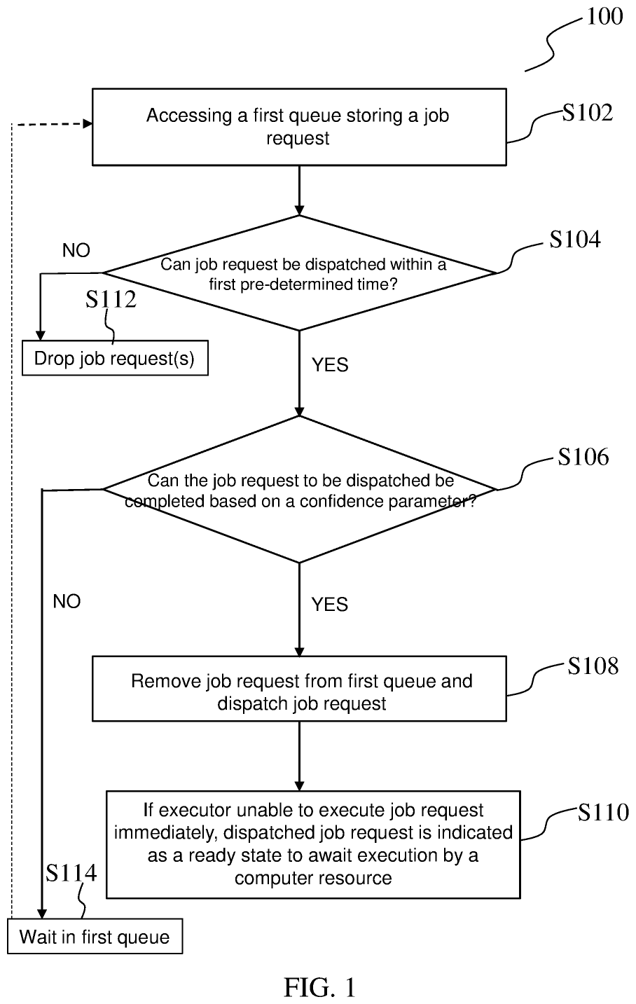

FIG. 1 shows a flow chart of a method 100 for scheduling job requests including the steps of: accessing a first queue storing at least one job request, and may be a plurality of job requests (step S102); determining if each of the plurality of job requests in the first queue can be dispatched within a first pre-determined time (step S104), wherein if the job request is determined to be dispatchable within the first pre-determined time, determining if the job request that is dispatchable can be completed based on a system resource parameter (step S106); wherein if the job request that is dispatchable is determined to be capable of being completed based on the system resource parameter, dispatch the job request (step S108).

The method 100 may be implemented as a scheduler in an operating system, a language and application framework, for example a web application framework, or as part of a terminal device congestion controller.

The first queue in step S102 may be referred to as a request queue. The request queue may be part of a computing resource associated with an existing computer, processor, application, terminal device, or a computer network. In some embodiments, the request queue may also be implemented as part of a device for scheduling job requests.

In step S104, the step of determining whether each job request can be dispatched within a first pre-determined time may be based on whether the job request can be dispatched based on first sufficient confidence parameter. The first sufficient confidence parameter may be stochastically derived based on historical system records. In some embodiments, the sufficient confidence parameter may be a time-out parameter. The time-out parameter may be determined dynamically according to system changes, or may be pre-fixed, statically determined and cannot be adjusted during operation. If a duration of the particular job request in the first queue is determined to have exceeded the time-out parameter, the job request may be dropped (see step S112). The dropped job request may be re-introduced to the first queue at a later time or permanently dropped. In the former case, the dropped job request may be re-introduced to the first queue by a user. In some embodiments, the time-out parameter may be shortened if it is determined that the computing environment the method 100 is operating within is at an overloaded state.

In step S106, the step of determining whether the job request may be completed may be based on a second sufficient confidence parameter. The second sufficient confidence parameter may be derived based on whether system resources are available to complete the job requests. In some embodiments, the step of determining whether the job request may be completed may include reading or scanning any general metric that is a direct consequence or result of a terminal device, system and/or application service overload caused by any factor. For example, one or more queues or buffers within a system, or a state of a job task, such as a job ready state, may be read to determine if the system is operating at an overload state. If the number of job ready states is zero, the second sufficient confidence parameter may be assigned a value at 100%, indicating that the job requests can confidently be completed. In some embodiments where the method 100 is implemented in a multi-core system, the number of cores may be taken into account to derive the sufficient confidence parameter. If the number of ready states is 1 or more, the confidence parameter in various values between 0% to 100%. For example, the number of job requests in a ready states empty job ready queue in conjunction with a higher number of cores within a system may result in a higher value assigned to the second sufficient confidence parameter. In some embodiments, the confidence parameter may be implemented as a binary parameter, i.e. 100% confidence or 0% confidence. In such an implementation, an empty job ready queue will be at 100% confidence.

In step S106, if the job request is determined not to be dispatchable, it continues to be stored in the first queue (step S114). The steps S102 to S106 may then be repeated until the job request is either dropped in accordance with step S112 or dispatched in accordance with step S108.

In step S108, the job request is dispatched for execution/processing in accordance with the device, system, application framework, and/or network protocols the method 100 is implemented thereon. If the dispatched job request is not immediately executed by a system resource, the dispatched job request may be assigned a ready state to await execution by the system resource (e.g. a core) (step S110). This may indicate that there is reasonably high confidence that the job request can be completed but no available computing resources are available at the particular instance to complete the job request.

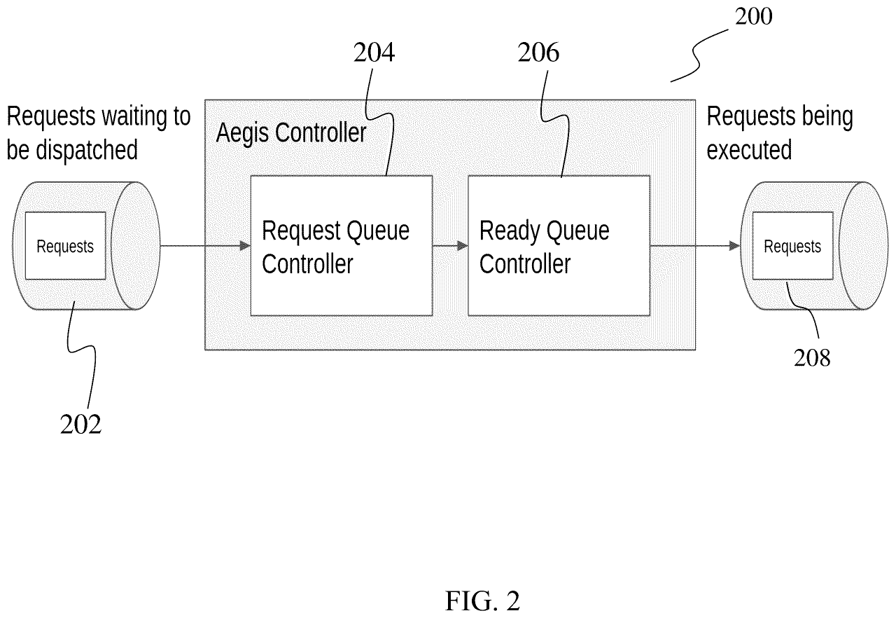

FIG. 2 shows an example of a device for scheduling job requests, in the form of a congestion controller 200. The congestion controller 200 may be implemented as part of a backend application congestion controller, or to manage congestion in the context of one or more application development and testing. In some embodiments, the congestion controller 200 may be implemented on a dispatcher layer of an application framework. The congestion controller 200 may comprise two controller modules in the form of a request queue controller module 204 and a ready queue controller module 206. In some embodiments, the request queue controller module 204 may be configured to implement steps S102, S104 and S112, and the ready queue controller module 206 may be configured to implement steps S106, S108 and S114. Job requests may be accessed from a request queue 202. Each job request in request queue 202 may have been queued based on known algorithms such as first-in-first out, or prioritized based on other conditions or level of importance associated with each job request. It is appreciated that there may not be an actual ready queue present, the ready queue is an imaginary concept based on the number of dispatched job requests assigned to ready state.

Although the request queue controller module 204 and ready queue controller module are described as separate elements for ease of description, it is contemplated that the two modules 204, 206 may be integrated as one single controller implementing the logic associated with modules 204 and 206.

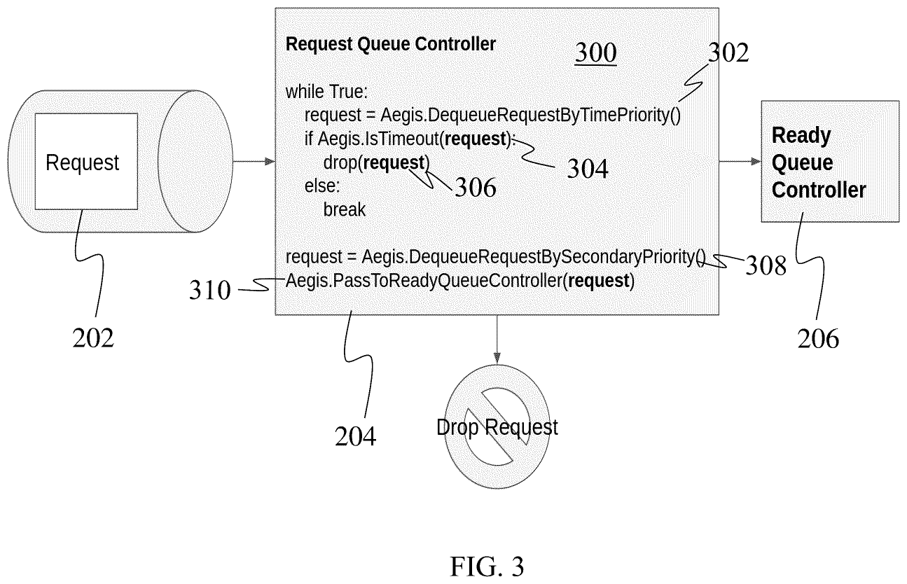

FIG. 3 shows an embodiment of the request queue controller 204, with pseudocode 300 which implements the method steps S102, S104 and S112. A function 302 is called to check if a job request in queue 202 can be dequeued based on the time it has spent in the queue 202 as a main priority. The check include calling a function 304 to determine if the job request has exceeded the time-out parameter, and if so, a function to drop the job request 306 is called. If the time-out parameter is not exceeded, the function 302 is exited and further checks based on function(s) associated with secondary priority 308 may be optionally called to determine if the job request should be dequeued or dropped. Such secondary priority function 308 may include prioritizing each job request by user-identity (user-ID) hash, or any other secondary functions. If the job request is below the time-out parameter and is not to be dropped based on the function associated with the secondary priority 308, the job request is pass on to the ready queue controller 206 via function 310.

In some embodiments, the function 304 adapts accordingly to the system's ability to dispatch job requests as early as possible. The time-out parameter may be dynamically adjusted such that job requests may be dropped earlier (function 306) during an actual system overload, and may be dropped later under normal circumstances.

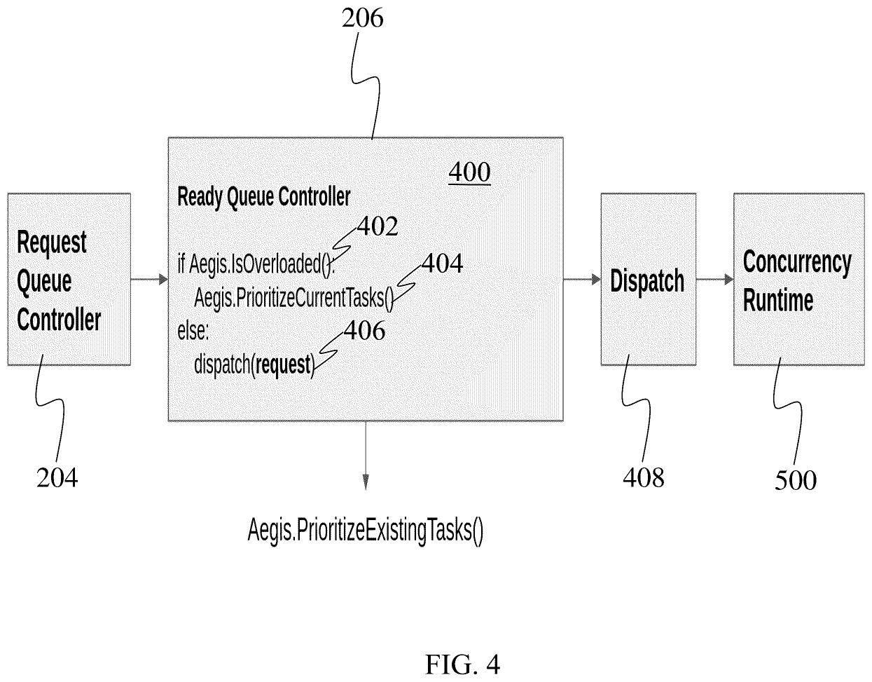

FIG. 4 shows an embodiment of the ready queue controller 206, with pseudocode 400 which implements the method steps S106, S108, S114. A function 402 is called to check if the system is overloaded, and if so, the system prioritizes the current job requests or tasks according to a prioritize current task function 404 and the new job request has to wait. Otherwise if the system is not overload, the new job request is dispatched in accordance with a dispatch function 406.

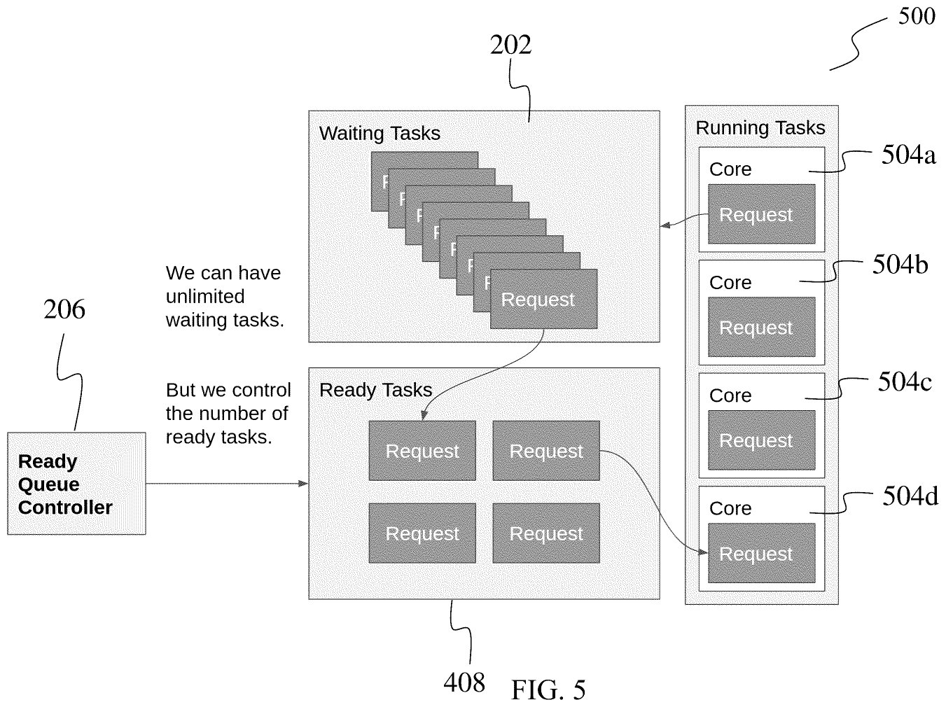

In some embodiments, the job request to be dispatched may be placed in a ready state. A dispatcher 408 may be configured to dispatch the job requests. Where parallel job requests may be run concurrently, for example in a multi-core processor system, there may be a concurrency runtime framework as shown in FIG. 5 to facilitate the dispatch of jobs.

FIG. 5 shows an embodiment of the ready queue controller 206 in a multi-core processor system 500 including four cores 504a to 504d. There may comprise a plurality of job requests in a wait queue, which may be the request queue 202, to be dispatched via the dispatcher 408. The job requests in the wait queue may theoretically be unlimited but may be constrained by computing resources (e.g. memory). The request queue 202 may store job requests that are not dropped but are queued for dispatch. The job requests in the request queue 202 may be dispatched and removed from the request queue 202 whenever the function 406 is executed to dispatch the job request. Job requests in the ready state may be dispatched as soon as possible to any of the available core 504a, 504b, 504c, or 504d to minimize built up of job requests in the ready queue 408.

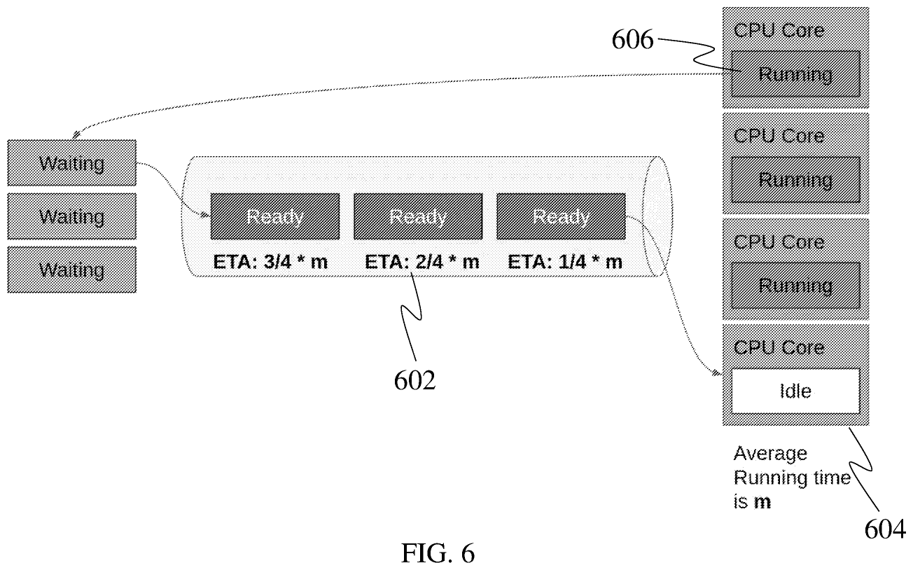

FIG. 6 shows an example scenario where jobs in a request queue (i.e. in a wait queue) are dispatched in accordance with the method 100 and controller 200. The dispatched jobs in ready state may be modelled as an imaginary ready queue 602 for ease of explanation. In the example shown in FIG. 6, there comprise three dispatched job requests in the ready state, that is, ready to be executed by a CPU core, each CPU core regarded as a physical executor. Each of the dispatched job request has an associated ETA expressed as a fraction of the average running time m. In some embodiments, the average running time m may be periodically computed and dynamically updated.

The total time taken to execute all the dispatch job requests (i.e. number of ready units) may be expressed in the following equation (1):

T_{ExecuitnToal}=(1+# Ready Units/# Physical Executors)*T_{RunningTotal}+T_{WaitingTotal} (1)

In other words, the total execution time is dependent on the number of ready units as the number of ready units tend towards infinity as defined by the Big O notation in equation (2);

T_{ExecutionTotal}=O(# Ready Units) (2)

It is appreciable that when job is dispatched, the job is ready to execute, but a system resource parameter, such as a physical executor 604 such as a central processing unit (CPU) or a core of a multi-core processor is not executing it. In the illustration shown in FIG. 6, there are three dispatched job requests in the ready state with one job request to be executed, after which two dispatched job requests will remain in the imaginary ready queue 602 until one of the running job requests 606 moves to a wait state or transit to a completed state. It follows therefore that the moment there is a dispatched job request in the ready state, the CPU or core 604 is likely already at its limit, and adding more job requests will slow down all existing tasks (not just the new job). It further follows that, a job request will be executed and be completed in the expected time once dispatched, if there are no dispatched job requests in the ready state. This corresponds to a 100% value assigned to the second sufficient confidence parameter.

It follows that as the number of job requests in the ready states increase, the longer each dispatched job request is required to wait in the imaginary ready queue before the job request can be picked up by the CPU or core for completion or execution. Therefore, the number of jobs in the ready state may be used as a system resource indicator, as it is a direct indicator of snowball based on Equation (2), regardless of what the cause is, even if the CPU is not 100% utilized (i.e. not CPU bound) but due to other factors.

In some embodiments relating to multi-core systems, as long as there are fewer ready job dispatches than the number of cores, the job request may be dispatched in accordance with steps S106 and S108, where the number of ready jobs in the ready queue are compared with the number of cores such that

```
if ready jobs < (is fewer than) the number of cores:
  dispatch
else:
  hold (wait) in queue
```

In some embodiments, the controller 200 may reside at the dispatcher layer of an application framework. In some embodiments, the controller 200 may replace a dispatcher/scheduler, or placed immediately before or after the dispatcher.

In some embodiments, the request queue 202 may include a dual-condition priority queue based on time and relative importance of each job request. For example, job requests may be grouped or associated with a user based on an identifier, such as a session identifier, so as to minimize the impact to more important user when deciding whether to drop one or more job requests.

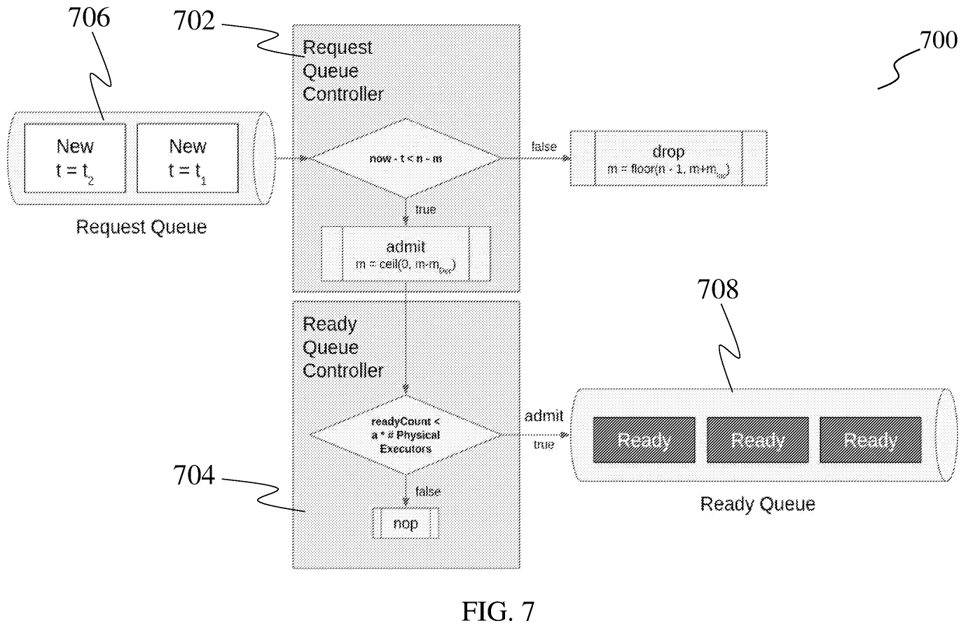

FIG. 7 shows another embodiment of the congestion controller 700 having request queue controller 702 and ready queue controller 704. Two job requests are shown in the request queue 706 having respective entry times t₁ and t₂ into the request queue 706. The request queue controller 702 regulates the job requests within the request queue by If a duration of the job request in the request queue 706 is determined to have exceeded the first pre-determined time, the job request is dropped from the request queue 706.

In some embodiments, the first pre-determined time is a function of the maximum duration allowable for the job request to remain in the first queue and an average execution time of previously dispatched job requests. The condition may be expressed as follows.

```
If (now − t < n −m) is true
  admit the job request for dispatch and update the average execution time
  m
else
  drop the job request from the request queue and update the average
  execution time m
```

where ‘now-t’ denotes the waiting time of the job request in the request queue 702, n is the maximum request queue waiting time, which may be typically 100 milliseconds (ms). It is appreciable that for every job request processed, feedback in the form of adjustments to average execution time dynamically adjust the overall condition to take into account changes in the system. In particular, the request queue controller regulates the number of job requests in the wait state by allowing short bursts buffering when not overloaded, and immediately eliminates standing queue when overloaded.

The ready queue controller 704 determines if the job request that is dispatchable can be completed. This includes a step of checking the number of previously dispatched job requests that are in a ready state (see imaginary queue 708) but not executed as an indication of whether one or more physical executors are operating in an overload state.

In some embodiments, the indicator is expressed as a ratio of the number of previously dispatched job request(s) in the ready state is to the number of physical executors capable of executing the job request. The ratio may be set to 0.1 or 0.2. The control logic of the ready queue controller 704 may be expressed as:

```
If (readyCount < a* #physical executors ) is true,
  dispatch the job request;
else
  do nothing (nop)
```

where ‘readyCount’ denotes the number of previously job requests in the ready state but not being executed by a physical executor, ‘a’ denotes an allowed ratio of number of previously job requests in the ready state/number of Physical Executors and is typically 0.1 or 0.2.

In the described embodiment, the total execution time in a worst a typical form may be expressed in the following mathematical expressions.

T_{WorstExecutionTotal}≤T_{ExecutionTotal}*(1αa)+n

T_{TypicalExecutionTotal}≤T_{ExecutionTotal}*(1+a) (3)

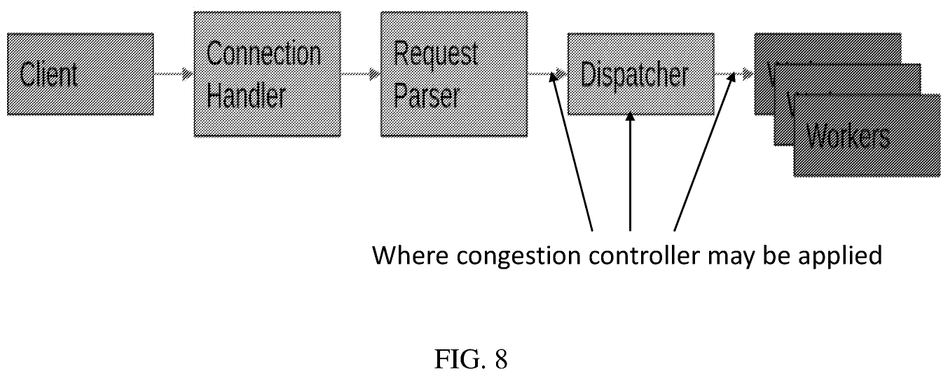

FIG. 8 illustrates a possible application of the congestion controller as described in a web framework as the dispatcher arranged to access job requests from request parser. Examples of such web framework includes Gunicorn, Gin, Spex, etc.

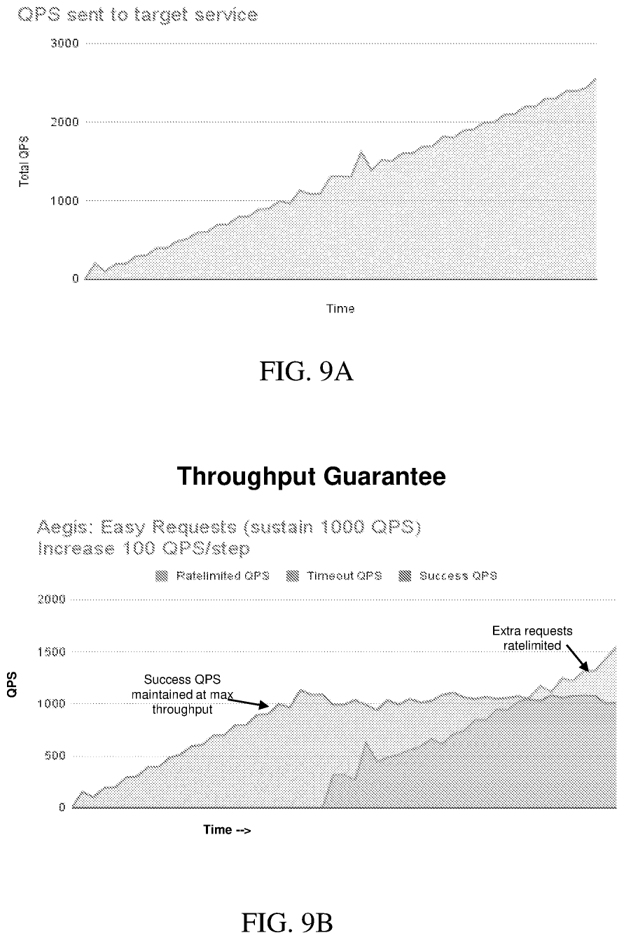

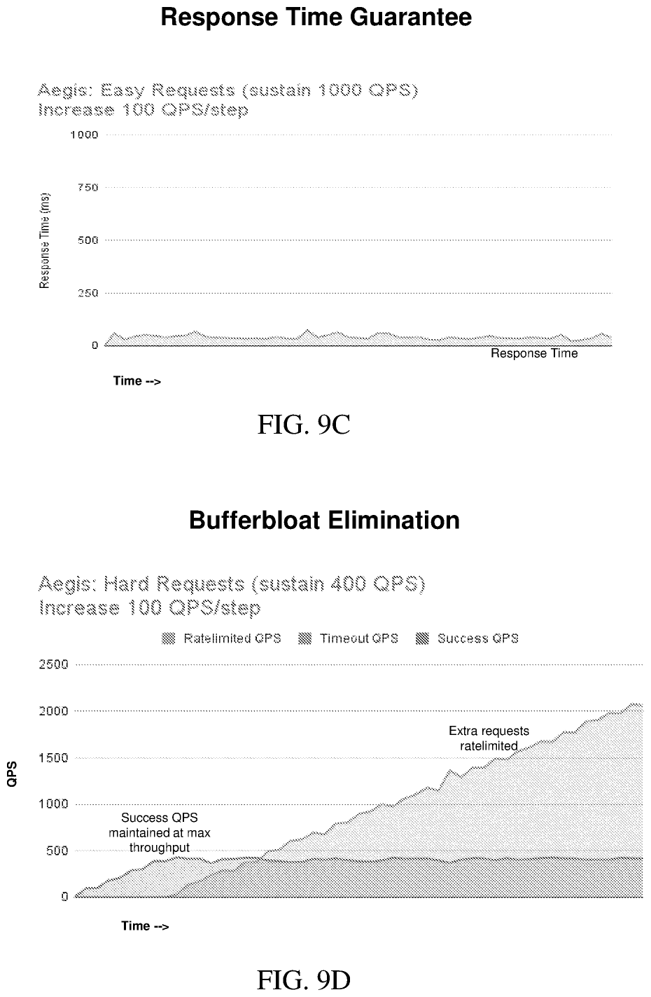

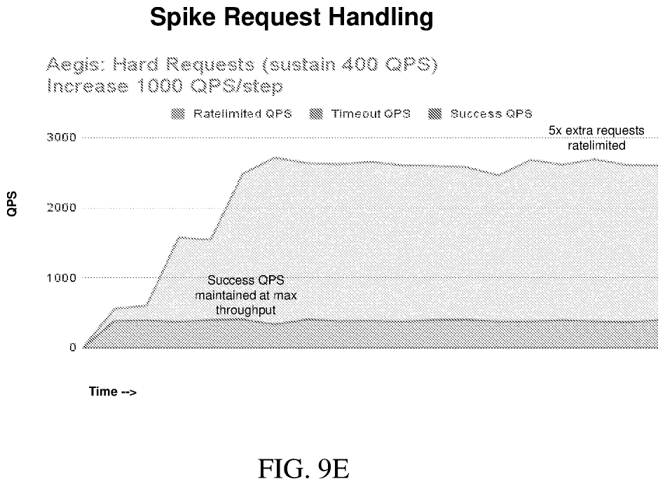

FIG. 9A to 9E illustrates the various test results of the congestion controller 700 demonstrating the efficacy of the congestion controller in throughput guarantee (FIG. 9B), response time guarantee (FIG. 9C), bufferbloat elimination (FIG. 9D), spike request handling (FIG. 9E), based on an increasing query per second (QPS) sent to a service such as that shown in FIG. 8. The controller is shown to be capable of maintains throughput and achieves higher QPS, even at 100% CPU utilization (see FIG. 9B), maintains response time throughout even at 100% CPU (see FIG. 9C), eliminates bufferbloat with no request pile ups in the entire request path (see FIG. 9D), and has no problem handling sudden spikes of requests, even if it each step is 4 to 5 times of its max capacity (see FIG. 9E). The Applicant has also discovered through tests that the congestion controller of the present disclosure outperform conventional schedulers at least in web framework applications.

It may be appreciated that the congestion controller and method for scheduling job requests is a dynamic controller, taking into account changes with zero controller response time (no TCP slow start adaptation, etc.). The controller can instantly adapt to different mixes of job requests difficulties and precisely rate limit the excess traffic. The controller and method of scheduling job requests allow services to use 100% CPU resources while maintaining optimal response times and throughput. The controller and method of scheduling job requests can work in a distributed environment across different numbers of clients and servers—there is no need to reconfigure rate limit after every scale up/down.

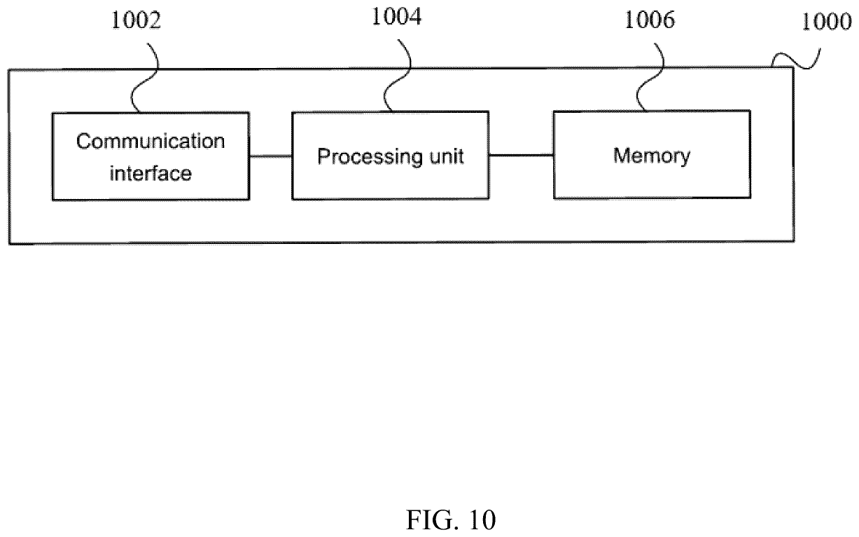

In the embodiment shown in FIG. 10, a controller device 1000 may be in the form of a standalone device and further include a processing unit 1004 and a memory 1006. The memory 1006 may be used by the processing unit 1004 to store, for example, the job requests in the form of executable files or codes. The device 1000 is configured to perform the method of FIG. 1. The device 1000 may implement the job request scheduling framework or may control another device to implement the framework. The controller device 1000 may include at least one computer-readable medium. One or more of the computer-readable media may be in the form of a non-transitory computer readable medium.

It is contemplated that the dispatcher of this disclosure can be applied to one or more of the following systems or applications, that is, producer/consumer systems, middleware (data middleware, traffic middleware, etc., porting into a kernel for control of processes in an operating system (including process/thread/coroutine scheduling, etc.), dispatching of jobs in manufacturing processes.

It is envisaged that the present disclosure allows services to operate optimally in the event of any unforeseen overloads which may arise from unexpected behaviours, including, but not limited to, changes in users' behaviour, reducing service outages and incidents especially during service peaks. It is envisaged that the present disclosure is aimed to achieve maximum throughput and minimum latency with precise rate limiting and zero controller adaptation time even during severe system overloads.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A method for scheduling job requests in an application layer or terminal device of a computer system, comprising the steps of:
accessing a first queue storing a job request;
determining if the job request in the first queue can be dispatched within a first pre-determined time, wherein if the job request is determined to be dispatchable within the first pre-determined time;
determining if the job request that is dispatchable can be executed based on a system resource parameter; and
dispatching the job request if the job request that is dispatchable is determined to be capable of being completed based on the system resource parameter; wherein the step of determining if the job request that is dispatchable is capable of being completed based on the system resource parameter includes a step of checking a number of previously dispatched job requests that are in a ready state but not executed as an indicator of the system resource parameter.

2. The method of claim 1, wherein if a duration of the job request in the first queue is determined to have exceeded the first pre-determined time, the job request is dropped from the first queue.

3. The method of claim 1, wherein the first pre-determined time is a function of a maximum duration allowable for the job request to remain in the first queue and an average execution time of previously dispatched job requests.

4. The method of claim 1, wherein the indicator of the system resource parameter is an indication of whether one or more physical executors are operating in an overload state.

5. The method of claim 4, wherein the indicator is expressed as a ratio of the number of previously dispatched job request(s) in the ready state is to the number of physical executors capable of executing the job request.

6. The method of claim 5, wherein the ratio is 0.1 or 0.2.

7. The method of claim 4, wherein the physical executors is part of a multi-core processor, each physical executor is a core of the multi-core processor.

8. The method of claim 7, wherein if the number of previously dispatched job request(s) in the ready state is less than the ratio multiplied by the number of physical executors in the multi-core processor, the job request is dispatchable.

9. The method of claim 1, wherein the job request is stored in the first queue if the job request is determined to be not dispatchable.

10. The method of claim 2, wherein if the job request in the first queue is determined to be dispatchable within the first pre-determined time, further comprising the step of prioritizing the job request by a user-identity (user-ID) hash.

11. A non-transitory computer-readable medium comprising program instructions, which, when executed by one or more processors, cause the one or more processors to perform the method of:
accessing a first queue storing a job request;
determining if the job request in the first queue can be dispatched within a first pre-determined time, wherein if the job request is determined to be dispatchable within the first pre-determined time;
determining if the job request that is dispatchable can be executed based on a system resource parameter; and
dispatching the job request if the job request that is dispatchable is determined to be capable of being completed based on the system resource parameter; wherein the step of determining if the job request that is dispatchable is capable of being completed based on the system resource parameter includes a step of checking a number of previously dispatched job requests that are in a ready state but not executed as an indicator of the system resource parameter.

12. The non-transitory computer readable medium of claim 11, wherein if a duration of the job request in the first queue is determined to have exceeded the first pre-determined time, the instructions are configured to cause the one or more processors to drop the job request from the first queue.

13. A job scheduler configured to be on a dispatcher layer of an application framework, or placed before or after the dispatcher, the scheduler device configured to:
access a first queue storing a job request;
determine if the job request in the first queue can be dispatched within a first pre-determined time, wherein if the job request is determined to be dispatchable within the first pre-determined time;
determine if the job request that is dispatchable is capable of being completed based on a system resource parameter; and
dispatch the job request if the job request that is dispatchable is determined to be capable of being completed based on the system resource parameter;
wherein the determination if the job request that is dispatchable is capable of being completed based on the system resource parameter includes a check of a number of previously dispatched job requests that are in a ready state but not executed as an indicator of the system resource parameter.

14. The job scheduler of claim 13, wherein if a duration of the job request in the first queue is determined to have exceeded the first pre-determined time, the job request is dropped from the first queue.

15. The job scheduler of claim 13, wherein the first pre-determined time is a function of a maximum duration allowable for the job request to remain in the first queue and an average execution time of previously dispatched job requests.

16. The job scheduler of claim 12, wherein the indicator of the system resource parameter is an indication of whether one or more physical executors are operating in an overload state.

17. The job scheduler of claim 16, wherein the indicator is expressed as a ratio of the number of previously dispatched job request(s) in the ready state is to the number of physical executors capable of executing the job request.

18. The job scheduler of claim 13, wherein the job scheduler is a congestion controller, the congestion controller comprises a communication interface arranged in data communication with a job request queue of a computer system, and a processing unit, and wherein the job request queue of the computer system is the first queue.

19. The job scheduler of claim 18, wherein the processing unit comprises a request queue controller module, and a ready queue controller module.

20. The job scheduler of claim 19, wherein the request queue controller module is used to determine if the job request in the first queue can be dispatched within a first pre-determined time and, if so, send the job request to the ready queue controller module.
